(19) United States
(12) Patent Application Publication
(10) Pub. No.: US 2006/0033613 A1
(43) Pub. Date: Feb. 16, 2006

(54) Temperature sensitive safety monitor for automotive vehicles

(76) Inventor: Patricia Reece, Lake City, FL (US)

Correspondence Address: STITES & HARBISON PLLC, 1199 NORTH FAIRFAX STREET, SUITE 900, ALEXANDRIA, VA, 22314, US

(21) Appl. No.: 11/201,310

(22) Filed: Aug. 11, 2005

Related U.S. Application Data
(60) Provisional application No. 60/601,649, filed on Aug. 16, 2004.

(51) Int. Cl. B60Q 1/00; G08B 23/00

(52) U.S. Cl. 340/457; 340/573.4

(57) ABSTRACT

A safety system for protecting an occupant or occupants of an automotive vehicle from temperature extremes is automatically activated when the vehicle engine is turned off. A computer-based monitor unit, connected to a temperature sensor, an occupancy detector and at least one alarm device, compares the sensed temperature with predetermined high and low temperature reference levels and if the sensed temperature is either above or below these levels, and the vehicle is indicated to be occupied, activates the alarm device so as to indicate an alarm condition within the interior of the vehicle.

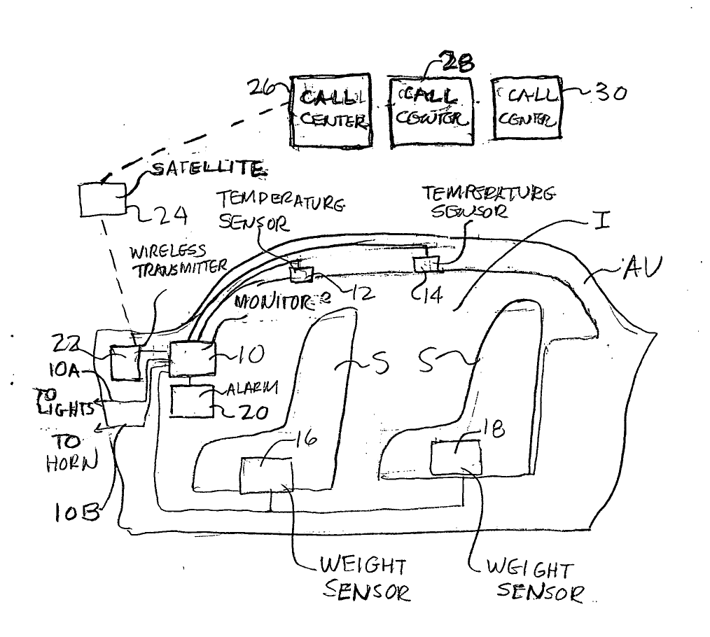

### CROSS REFERENCE TO RELATED APPLICATIONS

This application claims benefit of U.S. Provisional Application No. 60/601,649, filed Aug. 16, 2004 (which is hereby incorporated by reference).

### FIELD OF THE INVENTION

The present invention relates to safety systems for automobiles and the like vehicles and, more particularly, to a monitoring system that combats or prevents harm to vehicle occupants because vehicle temperatures that are too high or too low.

### BACKGROUND OF THE INVENTION

There are obvious dangers created for children and others when the temperature within an automobile becomes too high. In fact, the dangers are such that heat-related deaths have occurred when children have been left in cars by their parents. Similar problems occur with pets left in cars. Others for which this is a concern include the infirm and persons of such limited mobility as to be unable to get out of the car when the heat within the car reaches dangerous levels.

A related but not as widely recognized problem is created when the temperatures within a vehicle fall too low. In several conditions, injury and/or death can result. This can be a particular problem if there is a sudden unexpected precipitous drop in temperature or when sudden blizzards occur, and the occupant of the car is unable to cope for whatever reason with the weather change.

Patents of interest in this field, and in the field of temperature control for automotive vehicles, include Japanese Patent JP 4237623A2 to Kazuo et al and the following U.S. Pat. No. 6,642,838 to Barnas et al; U.S. Pat. No. 5,054,686 to Chuang; U.S. Pat. No. 6,345,767 to Burrus, IV, et al and U.S. Pat. No. 6,693,535 to Van Bosch et al.

The Kazuo et al. (JP4237623A2) reference discloses an automobile interior control device designed to prevent accidents caused by leaving passengers such as children inside a vehicle during the heat of the day. The control device includes a weight sensor, temperature sensor and an audible indicator. When the existence of a passenger is detected by said weight sensor, and the interior temperature, which is detected by the temperature sensor, reaches a value which is more than a specified reference value, a signal is produced so as to trigger fans to provide ventilation in the vehicle interior, or to actuate a speaker system to produce a voice warning so as to call any people around the automobile for help.

The Barnas et al. ('838) patent discloses a system detects the presence of

an occupant in a land vehicle after the engine of the land vehicle has been turned off. The system activates an alarm and a cooling system as well as unlocks the doors of the vehicle. Thus, help can be notified and the temperature of the vehicle near the occupant can be maintained cool until help arrives.

The Chuang ('686) patent discloses an automatic venting system for a vehicle. The system includes a plurality of motor operated vents in which the interior of the vehicle is monitored for the temperature as well as the presence of a living being, and a separate sensor is included for sensing precipitation outside the vehicle. When the interior of the vehicle is above a preselected threshold temperature, at least one of the vehicle vents is at least partially opened to cool the vehicle. Then, if precipitation is sensed, the open vent or vents are automatically closed unless a living being is sensed within the interior of the car, in which case one or more of the vents remains at least partially open even during the precipitation to provide sufficient ventilation and safety for the being in the car.

The Burrus, IV, et al. ('767) patent discloses a system for controlling the interior temperature of a vehicle. The system responds to increases in exterior temperature by reducing the interior temperature of the vehicle passenger compartment. The system includes a temperature sensor within the passenger compartment and a microprocessor programmed to respond to signals from the temperature sensor. The microprocessor operates to roll down windows and/or engage a fan or air conditioning unit until a desired and comfortable temperature is achieved within the passenger compartment. The user can pre-program the system with settings that are stored in a memory or use factory default settings. The system may also include a two-way paging and cellular network module to contact the vehicle operator when the system is engaged.

The Van Bosch ('535) patent discloses a passenger compartment monitoring and control system including a condition sensor disposed in the interior of the car that detects an undesirable condition. In response to a signal from the sensor, a controller contained within the vehicle and coupled to the sensor generates at least one control signal based on the comparison. A wireless communication device operably coupled to the controller then transmits a wireless signal in response to the at least one control signal. The transmitted wireless signal may be received by a vehicle operator's mobile station or by a call center.

### SUMMARY OF THE INVENTION

In accordance with one aspect of the invention, there is provided a system for monitoring the interior temperatures of an automotive vehicle so as to protect an occupant, such as a child or other person, from dangerous temperature levels, whether the temperatures are too hot or too cold. A temperature sensor detects the interior temperature and compares the temperature detected with both a preset upper temperature and a preset lower temperature. In one embodiment, separate sensors are used to sense hot and cold temperatures.

In preferred embodiments, the system also includes a weight sensor connected to the seats of the automotive vehicle for determining, based on the weight sensed, whether any of the seats are occupied. If the output of the weight sensor indicates that a seat is occupied and if the temperature detected is above the preset upper temperature or below the preset lower temperature, an alarm is activated to indicate that a dangerous situation exists.

The alarm is preferably an audible alarm although a visual alarm (e.g., a strongly blinking light) or combination of an audible and visual alarms can also be used.

Further, in a preferred embodiment, a transmitter produces a signal which is relayed, preferably using a satellite frequency, to an automotive service provider such as OnStar® or ATX Technologies®, using a wireless communication system such as the Internet or a PSTN, informing the service provider as to the location of the vehicle and enabling help to be dispatched to the location by the appropriate authorities, e.g., the police, EMS, the fire department, etc.

In accordance with one aspect of the invention, a monitoring system for an engine-driven automotive vehicle, said monitoring system being automatically activated when the engine of the automotive vehicle is turned off and said monitoring system comprising:

at least one temperature sensor for sensing the temperature in the interior of the automotive vehicle and for producing a corresponding output;

detector means for detecting the presence of a living being within the interior of the automotive vehicle and for, responsive to detecting the presence of a living being within the interior of the automotive vehicle, producing a corresponding output signal;

at least one alarm device for, when activated, producing an alarm signal for indicating an alarm condition within the interior of the automotive vehicle; and

a computer-based monitor means, connected to the at least one temperature sensor, said detector means and the at least one alarm device, for comparing the output from the at least one temperature sensor with a predetermined high temperature reference level which is unsafe to exceed and with a predetermined low temperature reference level which is unsafe to fall below, and for, responsive to the temperature sensed by the at least one sensor exceeding the high temperature reference level or the temperature sensed by the at least one sensor falling below the low temperature reference level, and responsive to receiving said output signal from said detector means, activating the at least one alarm device so as to indicate an alarm condition within the interior of the automotive vehicle.

In one preferred embodiment, the detector means comprises weight sensor means, associated with the seats of the automotive vehicle, for detecting whether any of the seats of the automotive vehicle are occupied.

In one important implementation, the at least one temperature sensor comprises at least two temperature sensors.

Preferably, the at least one temperature sensor is located in an interior structural portion of the automotive vehicle defining the interior of the automotive vehicle.

In an important embodiment, the at least one alarm device comprises a transmitter, connected to said monitor means, for transmitting an alarm signal to a remote call center so as to enable alerting of personnel that can be of help to the living being in the interior of the automotive vehicle. Advantageously, the transmitter is adapted to transmit an alarm signal via satellite to a plurality of call centers.

In one embodiment, the at least one alarm device comprises an audio alarm within the automotive vehicle.

In another embodiment, the at least one alarm device comprises a visual alarm device within the automotive vehicle.

In one implementation, the monitoring means is adapted to turn on vehicle lights in response to an alarm condition.

In another implementation, the monitoring means is adapted to activate a vehicle horn in response to an alarm condition.

In accordance with a further aspect of the invention, there is provided a monitoring system for an engine-driven automotive vehicle, said monitoring system being automatically activated when the engine of the automotive vehicle is turned off and said monitoring system comprising:

at least one temperature sensor for sensing the temperature in the interior of the automotive vehicle and for producing a corresponding output;

detector means for detecting the presence of a living being within the interior of the automotive vehicle and for, responsive to detecting the presence of a living being within the interior of the automotive vehicle, producing a corresponding output signal;

at least one alarm device for, when activated, producing an alarm signal for indicating an alarm condition within the interior of the automotive vehicle; and

a computer-based monitor means, connected to the at least one temperature sensor, said detector means and the at least one alarm device, for comparing the output from the at least one temperature sensor with a predetermined low temperature reference level which is unsafe to fall below, and for, responsive to the temperature sensed by the at least one sensor falling below the low temperature reference level, and responsive to receiving said output signal from said detector means, activating the at least one alarm device so as to indicate an alarm condition within the interior of the automotive vehicle.

Further features and advantages of the present invention will be set forth in, or apparent from, the detailed description of preferred embodiments thereof which follows.

### BRIEF DESCRIPTION OF THE DRAWING

The single FIGURE in the drawings is a schematic representation of a portion of an automotive vehicle showing incorporated therein a detection and warning system in accordance with a preferred embodiment of the invention.

### DESCRIPTION OF THE PREFERRED EMBODIMENTS

Referring to the drawings, an automotive vehicle AV, such as a family automobile, includes an interior I having seats S therein. Vehicle AV has incorporated therein a system of the invention according to a preferred embodiment of the invention.

The system of this embodiment is automatically turned on when the engine of the automotive vehicle AV is turned off and includes a computer-based monitor or monitoring unit 10 to which is connected a temperature sensor 12. The sensor 12 is shown as being incorporated in the roof of vehicle AV but could be located in other suitable locations in the vehicle AV that enable the sensor 12 to detect the temperature of the interior I of vehicle AV. As indicated above, in one preferred embodiment, two temperature sensors are used, with a second optional sensor being denoted 14 in the drawings. In this embodiment, one of the sensors 12, 14 could be used for sensing hot interior temperatures and the other of sensor 12, 14 for sensing cold interior temperatures, although in another preferred embodiment a single temperature sensor is used for sensing the temperature over the complete temperature range of interest. In the latter case, the monitor 10 compares the sensed temperature with both high and low preset temperature levels. In the former case, the monitor 10 compares the temperature output of each sensor with an appropriate preset level, i.e., a high or low level. Two (or more) sensors can also be used in a redundant arrangement to ensure that a good temperature reading is obtained from at least one sensor. The preset or predetermined levels are set at temperatures which are determined to be unsafe if exceeded on the high side, and, on the low side, are determined to be unsafe if the interior temperature falls below that level.

Weight sensors 16 and 18 sense the weight on the seats S and produce a characteristic output signal when the corresponding seat S is occupied. The weight level can be preset as desired so as, for example, to detect the presence of a small child. The weight level is adjustable so as to address the expected occupant whether it be a pet, or someone else, such as an infirm person or a person of such limited mobility to be able to get out of the vehicle AV.

The monitor 10 receives the output signals from temperature sensor 12 (and/or temperature sensor 14) and from weight sensors 16 and 18, and if the weight signal indicates that at least one seat is occupied and if the sensed temperature signal exceeds the preset high level or is below the preset low level, thereby indicating a dangerous situation for the occupant, an associated alarm 20 is activated. As indicated above, alarm 20 is preferably an audible alarm although other alarms or combination of alarms can be used. Such an alarm will alert those in the vicinity as to the danger. Monitor 10 can also cause the vehicle horn to sound as indicated by connection 10a and/or the vehicle lights to be turned on as indicated by connection 10b.

In a preferred embodiment, monitor 10 is also connected to a wireless transmitter 22 so that when a dangerous situation is detected, the transmitter 22 can send a suitable signal to a suitable wireless call center. In the embodiment illustrated, transmitter 22 triggers a satellite 24 using a satellite frequency signal so that the latter signals an appropriate wireless call center such as one of call centers 26, 28 and 30. In this embodiment, transmitter 22 would be programmed to interface with the independent call center (e.g., call center 26, 28 or 30) of the vehicle owner's choice. As indicated above, the call center is preferably an automotive service provider such as OnStar® or ATX Technologies®. In this way, the location of the automotive vehicle AV can be determined and help, in whatever form that is appropriate, can be dispatched to that location. This help could, of course, be from the police, fire department, rescue squad, medical team, sheriff's department, EMS, etc.

Although the invention has been described above in relation to preferred embodiments thereof, it will be understood by those skilled in the art that variations and modifications can be effected in these preferred embodiments without departing from the scope and spirit of the invention.

What is claimed:

1. A monitoring system for an engine-driven automotive vehicle, said monitoring system being automatically activated when the engine of the automotive vehicle is turned off and said monitoring system comprising:
at least one temperature sensor for sensing the temperature in the interior of the automotive vehicle and for producing a corresponding output;
detector means for detecting the presence of a living being within the interior of the automotive vehicle and for, responsive to detecting the presence of a living being within the interior of the automotive vehicle, producing a corresponding output signal;
at least one alarm device for, when activated, producing an alarm signal for indicating an alarm condition within the interior of the automotive vehicle; and
a computer-based monitor means, connected to the at least one temperature sensor, said detector means and the at least one alarm device, for comparing the output from the at least one temperature sensor with a predetermined high temperature reference level which is unsafe to exceed and with a predetermined low temperature reference level which is unsafe to fall below, and for, responsive to the temperature sensed by the at least one sensor exceeding the high temperature reference level or the temperature sensed by the at least one sensor falling below the low temperature reference level, and responsive to receiving said output signal from said detector means, activating the at least one alarm device so as to indicate an alarm condition within the interior of the automotive vehicle.

2. A monitoring system according to claim 1 wherein the automotive vehicle includes seats and said detector means comprises weight sensor means, associated with the seats of the automotive vehicle, for detecting whether any of the seats of the automotive vehicle are occupied.

3. A monitoring system according to claim 1 wherein the at least one temperature sensor comprises at least two temperature sensors.

4. A monitoring system according to claim 1 wherein the at least one temperature sensor is located in an interior structural portion of the automotive vehicle defining the interior of the automotive vehicle.

5. A monitoring system according to claim 1 wherein the at least one alarm device comprises a transmitter, connected to said monitor means, for transmitting an alarm signal to a remote call center so as to enable alerting of personnel that can be of help to the living being in the interior of the automotive vehicle.

6. A monitoring system according to claim 5 wherein the transmitter is adapted to transmit an alarm signal via satellite to a plurality of call centers.

7. A monitoring system according to claim 1 wherein the at least one alarm device comprises an audio alarm within the automotive vehicle.

8. A monitoring system according to claim 1 wherein the at least one alarm device comprises a visual alarm device within the automotive vehicle.

9. A monitoring system according to claim 1 wherein said monitoring means is adapted to turn on vehicle lights in response to an alarm condition.

10. A monitoring system according to claim 1 wherein said monitoring means is adapted to activate a vehicle horn in response to an alarm condition.

11. A monitoring system for an engine-driven automotive vehicle, said monitoring system being automatically activated when the engine of the automotive vehicle is turned off and said monitoring system comprising:
at least one temperature sensor for sensing the temperature in the interior of the automotive vehicle and for producing a corresponding output;
detector means for detecting the presence of a living being within the interior of the automotive vehicle and for, responsive to detecting the presence of a living being within the interior of the automotive vehicle, producing a corresponding output signal;
at least one alarm device for, when activated, producing an alarm signal for indicating an alarm condition within the interior of the automotive vehicle; and
a computer-based monitor means, connected to the at least one temperature sensor, said detector means and the at least one alarm device, for comparing the output from the at least one temperature sensor with a predetermined low temperature reference level which is unsafe to fall below, and for, responsive to the temperature sensed by the at least one sensor falling below the low temperature reference level, and responsive to receiving said output signal from said detector means, activating the at least one alarm device so as to indicate an alarm condition within the interior of the automotive vehicle.

12. A monitoring system according to claim 11 wherein the automotive vehicle includes seats and said detector means comprises weight sensor means, associated with the seats of the automotive vehicle, for detecting whether any of the seats of the automotive vehicle are occupied.

13. A monitoring system according to claim 11 wherein the at least one temperature sensor comprises at least two temperature sensors.

14. A monitoring system according to claim 11 wherein the at least one temperature sensor is located in an interior structural portion of the automotive vehicle defining the interior of the automotive vehicle.

15. A monitoring system according to claim 11 wherein the at least one alarm device comprises a transmitter, connected to said monitor means, for transmitting an alarm signal to a remote call center so as to enable alerting of personnel that can be of help to the living being in the interior of the automotive vehicle.

16. A monitoring system according to claim 15 wherein the transmitter is adapted to transmit an alarm signal via satellite to a plurality of call centers.

17. A monitoring system according to claim 11 wherein the at least one alarm device comprises an audio alarm within the automotive vehicle.

18. A monitoring system according to claim 11 wherein the at least one alarm device comprises a visual alarm device within the automotive vehicle.

19. A monitoring system according to claim 11 wherein said monitoring means is adapted to turn on vehicle lights in response to an alarm condition.

20. A monitoring system according to claim 11 wherein said monitoring means is adapted to activate a vehicle horn in response to an alarm condition.
